(19) United States
(12) Patent Application Publication
(10) Pub. No.: US 2009/0172213 A1
(43) Pub. Date: Jul. 2, 2009

(54) COMMAND COMPLETION DETECTION IN A MASS STORAGE DEVICE

(76) Inventors: Sowmiya Jayachandran, Portland, OR (US); Jawad B. Khan, Hillsboro, OR (US); Randall K. Webb, Hillsboro, OR (US); Robert W. Faber, Hillsboro, OR (US)

Correspondence Address: INTEL CORPORATION;c/o CPA Global, P.O. BOX 52050, MINNEAPOLIS, MN, 55402, US

(21) Appl. No.: 11/968,042

(22) Filed: Dec. 31, 2007

(51) Int. Cl. G06F 3/00

(52) U.S. Cl. 710/19

(57) ABSTRACT

In some embodiments, after a hold off time following issuance of a memory command has elapsed, a status read operation is performed to determine a status of the memory command. In some embodiments, if the memory command has not yet completed, a polling interval is used to perform a status read operation to determine the status of the memory command after the polling interval has expired, and repeating the process until the memory command has been completed. Other embodiments are described and claimed.

### TECHNICAL FIELD

The inventions generally relate to command completion detection in a mass storage device.

### BACKGROUND

Mass storage devices may include a number of memory devices, such as NAND memory devices, phase change devices, etc. The number of chip enables (CEs) that need to be used will vary depending upon the capacity of the storage device (for example, a storage device might have any number of CEs including one or more CEs). If a READY/BUSY# pin, for example, is used to check for command completion, then one or more additional pins equal to the number of CEs would be required on the chip. This is an undesirable situation, since it significantly increases the cost of the controller ASIC (Application Specific Integrated Circuit), for example. If continuous polling of a status register internal to the memory device is used, then excessive polling results in wasted power due to excessive interface activity and inefficient channel controller operation. If the READY/BUSY# pins are shared among the memory devices, then the slowest outstanding command will determine when the controller completes the commands. For example, in a storage device with NAND memories, a 20 microsecond (20 us) READ command could wait for a 2 millisecond (2 ms) BLOCK ERASE COMMAND. Therefore, the inventors have recognized that a need exists for an improved implementation of command completion detection in a mass storage device.

### BRIEF DESCRIPTION OF THE DRAWINGS

The inventions will be understood more fully from the detailed description given below and from the accompanying drawings of some embodiments of the inventions which, however, should not be taken to limit the inventions to the specific embodiments described, but are for explanation and understanding only.

FIG. 1 illustrates a system according to some embodiments of the inventions.

FIG. 2 illustrates timing diagrams according to some embodiments of the inventions.

FIG. 3 illustrates a timing diagram according to some embodiments of the inventions.

### DETAILED DESCRIPTION

Some embodiments of the inventions relate to command completion detection in a mass storage device.

In some embodiments, after a hold off time following issuance of a memory command has elapsed, a status register internal to the memory device is read to determine the status of the memory command. In some embodiments, a polling interval is used to perform a status read operation after every time the polling operation has elapsed before performing a status check of completion of the memory command.

In some embodiments a controller is to wait a hold off time after a memory command is issued. After the hold off time has elapsed following the issuance of the memory command, the controller is to perform a status read operation to determine a status of the memory command. In some embodiments, the controller waits a polling interval before performing a status check of completion of the NAND command.

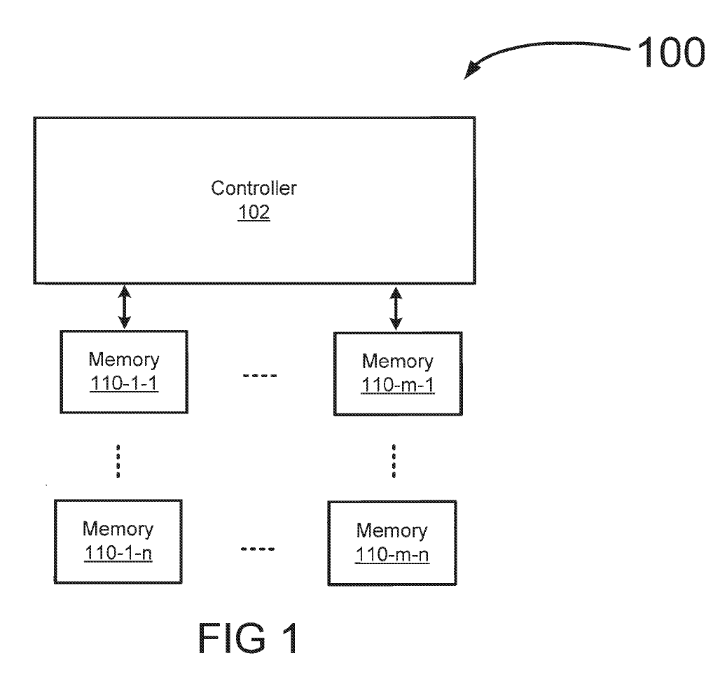

FIG. 1 illustrates a system 100 according to some embodiments. In some embodiments system 100 is a mass storage device (for example in some embodiments, a solid state storage device) including one or more memory devices. In some embodiments system 100 is a multi-channel mass storage device with any number of memory devices attached in a parallel manner. However, in some embodiments system 100 is a mass storage device with any number of memory devices attached in a serial manner. FIG. 1 shows a controller 102 connected to one or more memory devices 110-1-1, . . . , 110-1-n, . . . , 110-m-1, . . . , 110-m-n (collectively “memory devices 110”). In some embodiments m can be any number that is one or more and n can be any number that is one or more, where m and n can be the same number but do not have to be the same number. Thus, there are m×n memory devices such that this number of m×n memory devices is a number that is one or more. In some embodiments system 100 includes a controller 102 with a plurality of memory devices 110 coupled thereto. In some embodiments controller 102 is a channel controller and/or in some embodiments controller 102 is a host controller and/or in some embodiments controller 102 is any type of controller. Each of the memory devices 110 has one or more chip enables (CEs). In some embodiments the CEs are all flash memory chip enables and/or NAND flash memory chip enables. In some embodiments other memory devices and/or technologies may be used.

In some embodiments off-the-shelf NAND flash memory devices may be used for the non-volatile data storage (that is, for memory devices 110). A unique property of NAND flash memory is that a minimum of time must elapse after the issuance of the command before a certain operation can be completed. For example, on one 72 nm single level cell (SLC) NAND (SD74) it typically takes approximately 220 microseconds (220 us) to complete a program operation and approximately 1.5 milliseconds (1.5 ms) to complete a block erase operation.

The controller 102 implements functionality to control the operation of the memory devices. These controllers implement the protocol used by the memory devices including sending the various commands along with the data and reading the status back.

In some embodiments, the controller 102 is responsible for interpreting host commands from a host computer. The controller 102 typically has a Central Processing Unit (CPU) which is used in conjunction with some special hardware to perform this function.

Some mass storage devices must support several memory devices. The number of chip enables (CEs) that need to be used will vary depending upon the capacity of the storage device (for example, a mass storage device might have any number of CEs, including one CE or more CEs).

FIG. 1 illustrates a controller 102 coupled to memories 110 in both a parallel and a serial manner. However, in some embodiments controller 102 is coupled to memory devices in other ways. For example, in some embodiments the controller is coupled to the memory devices in a single chain and/or serially, and/or in a parallel manner, and/or in any other manner.

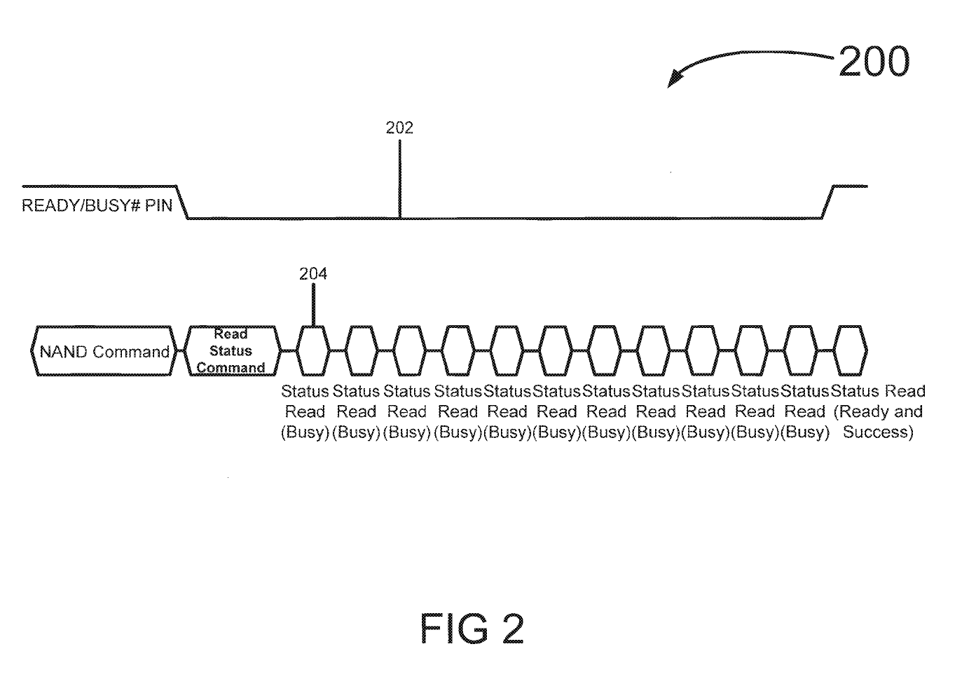

FIG. 2 illustrates timing diagrams 200 including timing diagram 202 and timing diagram 204. Timing diagrams 202 and 204 illustrate two methods of indicating command completion in NAND flash devices, for example. Timing diagram 202 illustrates a READY/BUSY# pin and timing diagram 204 illustrates a polling scheme.

Timing diagram 202 illustrates a READY/BUSY# pin timing. Each chip enable (CE) in a mass storage device, for example, includes a READY/BUSY# pin, where the logical level of the pin provides an indication of command completion. In timing diagram 202, if a READY/BUSY# pin, for example, is used to check for command completion, then one or more additional pins would be required on the chip. The number of additional pins would be equal to, for example, the number of CEs. This is an undesirable situation, since it significantly increases the cost of the controller ASIC (Application Specific Integrated Circuit), for example. If the READY/BUSY# pins are shared within the channel, then the slowest outstanding command will determine when the controller completes the commands. For example, in a mass storage device with NAND memories, a 20 microsecond (20 us) READ command could wait for a 2 millisecond (2 ms) BLOCK ERASE COMMAND.

Timing diagram 204 illustrates a timing diagram where continuous polling is used. Timing diagram 204 illustrates how a status register inside the memory device can be periodically read until the timing diagram 204 indicates whether a command was completed successfully. The status register can be read using a specific memory protocol utilizing the data bus. Where continuous polling is used, then excessive polling results in wasted power due to excessive interface activity and inefficient channel controller operation.

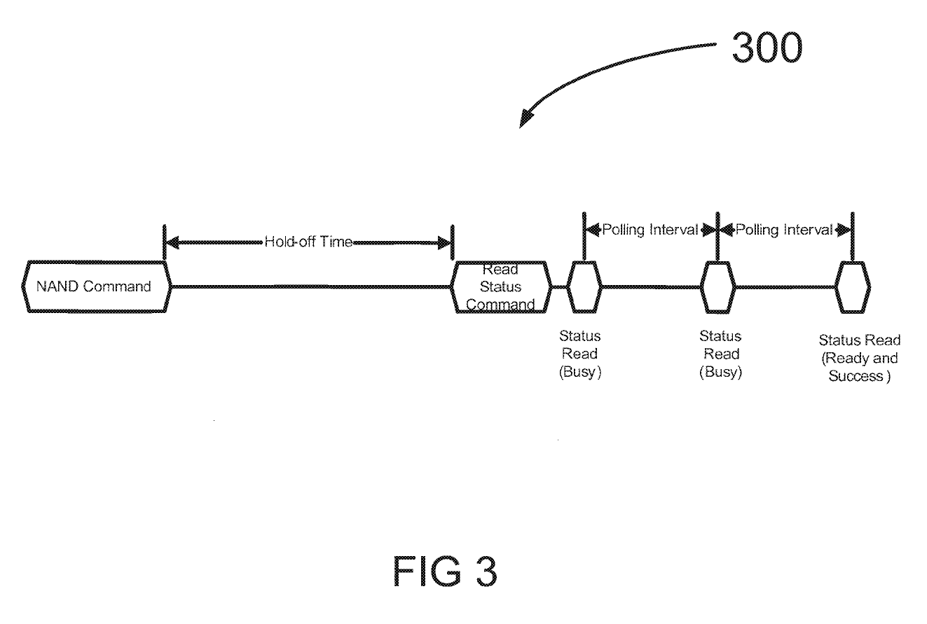

FIG. 3 illustrates a timing diagram 300 according to some embodiments. Timing diagram 300 illustrates an improved implementation of command completion detection in a mass storage device. In some embodiments timing diagram 300 illustrates a command completion detection methodology in which only a minimal number of polling cycles are used to obtain the status of a memory command, resulting in lower power consumption and highly efficient solid state drive controllers.

In some embodiments, the host controller (for example, host controller 102) includes a set of registers that store and provide typical values of hold-off times which must elapse before polling should begin after any command. In some embodiments, the host controller (for example, host controller 102) also includes a set of registers that store and provide a polling interval for each command type. The polling interval is a time interval to be used after the hold-off time for the respective command type has elapsed. In this manner, an optimal hold-off time and optimal polling time is specified for each command type supported by the storage device.

In some embodiments the stored optimal hold-off time and/or the stored optimal polling time for each type of command may be updated. For example, a running average of completion times may be kept for different commands (and/or on different CEs) and the registers storing the hold-off times for each command and/or the registers storing the polling intervals for each command may be periodically and/or continuously updated using, for example, constantly changing average command completion times.

In some embodiments, unnecessary status polling cycles are eliminated, resulting in lower power consumption. Power is saved by delaying the status checking until the hold time has elapsed. The hold time varies depending on, for example, the type of command such as read, write, erase, etc. After the hold time has elapsed sampling occurs only at the end of every polling interval, which also varies depending on the type of command, such as read, write, erase, etc. This minimal polling arrangement saves additional power. For example, in a mass storage device with NAND memories, using traditional polling without a hold time and/or polling interval several hundred status reads might occur while waiting for a READ command to complete, and several thousand might occur while waiting for an ERASE command. In some embodiments, as few as one might occur.

In some embodiments a lower pin count is possible compared to implementations using a separate pin for each chip enable (CE) in a solid state storage device. That is, in some embodiments it is not necessary to provide a separate READY/BUSY# pin for each CE.

In some embodiments an efficient controller may be implemented. New commands, data transfers, and/or status checking can occur for different CEs sharing the same interface because cycles are not wasted performing continuous status polling. This allows the controller to be more efficient.

Although some embodiments have been described herein as being implemented using memory devices and/or in some embodiments as using a particular type of memory device, it is noted that according to some embodiments any type of memory device may be used. For example, in some embodiments, memory devices such as NAND memory devices, and/or any other type of memory devices may be used. In some embodiments, any type of memory device may be used, as long as that memory device has, for example, a status register that can be read to check the status of the memory command that was sent out.

Although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, the interfaces that transmit and/or receive signals, etc.), and others.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Although flow diagrams and/or state diagrams may have been used herein to describe embodiments, the inventions are not limited to those diagrams or to corresponding descriptions herein. For example, flow need not move through each illustrated box or state or in exactly the same order as illustrated and described herein.

The inventions are not restricted to the particular details listed herein. Indeed, those skilled in the art having the benefit of this disclosure will appreciate that many other variations from the foregoing description and drawings may be made within the scope of the present inventions. Accordingly, it is the following claims including any amendments thereto that define the scope of the inventions.

What is claimed is:

1. A method comprising:
waiting a hold off time after a memory command has issued; and
after the hold off time has elapsed following the issuance of the memory command, performing a status read operation to determine a status of the memory command.

2. The method of claim 1, further comprising:
if the status read operation indicates that the memory command has not been completed, then waiting a polling interval after performing the status read operation;
after the polling interval has elapsed, then performing another status read operation to determine the status of the memory command; and
if the status read operation performed after waiting for the polling interval indicates that the memory command has not been completed, repeating waiting the polling interval before performing another status read operation each time until receiving an indication that the memory command has been completed.

3. The method of claim 1, wherein the hold off time varies depending on the type of the memory command.

4. The method of claim 1, further comprising updating the hold off time.

5. The method of claim 4, wherein the updating is dependent on changing average memory command completion times.

6. The method of claim 2, wherein the hold off time and the polling interval vary depending on the type of the NAND command.

7. The method of claim 2, further comprising updating the hold off time and/or the polling interval.

8. The method of claim 7, wherein the updating is dependent on changing average memory command completion times.

9. An apparatus comprising:
one or more memory devices; and
a controller to wait a hold off time after a memory command has issued for the memory, and after the hold off time has elapsed following the issuance of the memory command, to perform a status read operation to determine a status of the memory command.

10. The apparatus of claim 9, the controller further to wait a polling interval after the performing of the status command operation if the status read operation indicates that the memory command has not been completed, to perform another status read operation to determine the status of the memory command after the polling interval has elapsed, and to repeat waiting the polling interval before performing another status read operation each time if the status read operation performed after waiting for the polling interval indicates that the memory command has not been completed, the repeating to continue until receiving an indication that the memory command has been completed.

11. The apparatus of claim 9, wherein the hold off time varies depending on the type of the memory command.

12. The apparatus of claim 9, the controller to update the hold off time.

13. The apparatus of claim 12, the controller to update the hold off time in response to changing average memory command completion times.

14. The apparatus of claim 10, wherein the hold off time and the polling interval vary depending on the type of the memory command.

15. The apparatus of claim 10, the controller to update the hold off time and/or the polling interval.

16. The apparatus of claim 14, wherein the updating is dependent on changing average memory command completion times.

17. A method comprising:
waiting a polling interval at some point after a memory command has issued;
after the polling interval has elapsed, then performing a status read operation to determine the status of the memory command; and
if the status command operation performed after waiting for the polling interval indicates that the memory command has not been completed, repeating waiting the polling interval before performing another status read operation each time until receiving an indication that the memory command has been completed.

18. The method of claim 17, further comprising updating the polling interval.

19. The method of claim 18, wherein the updating is dependent on changing average memory command completion times.

20. The method of claim 17, wherein the polling interval varies depending on the type of the memory command.

21. An apparatus comprising:
one or more memory devices; and
a controller to wait a polling interval at some point after a memory command has issued for the memory, and after the polling interval has elapsed, to perform a status read operation to determine a status of the memory command, and to repeat waiting the polling interval before performing another status read operation each time until receiving an indication that the memory command has been completed.

22. The apparatus of claim 21, the controller further to update the polling interval.

23. The apparatus of claim 21, the controller further to update the polling interval in a manner that is dependent on changing average memory command completion times.

24. The apparatus of claim 21, the controller further to vary the polling interval depending on the type of the memory command.
